(19) United States
(12) Patent Application Publication
(10) Pub. No.: US 2012/0262145 A1
(43) Pub. Date: Oct. 18, 2012

(54) POWER-SUPPLY MODULE

(75) Inventors: Da-Jung Chen, Taoyuan County 325 (TW); Chun-Tiao Liu, Hsinchu City 300 (TW)

(73) Assignee: CYNTEC CO., LTD, Hsinchu (TW)

(21) Appl. No.: 13/481,887

(22) Filed: May 28, 2012

Related U.S. Application Data
(63) Continuation-in-part of application No. 12/971,671, filed on Dec. 17, 2010.
Application No. 12/971,671 is a division of application No. 12/143,143, filed on Jun. 20, 2008, now abandoned.

(30) Foreign Application Priority Data
Feb. 18, 2008 (TW) 97105555

(51) Int. Cl. G05F 3/02; H01F 41/00

(52) U.S. Cl. 323/311; 29/602.1

(57) ABSTRACT

A power-supply module includes at least one power-supply component, an inductor and a package. The inductor is disposed over the at least one power-supply components, and the at least a power-supply component and the inductor are disposed within the package. Besides, the power-supply module further comprises a printed circuit board, and the at least one power-supply component and the inductor are mounted to the printed circuit board. Moreover, the inductor comprises a plurality of leads that support the inductor over the at least one power-supply component.

### CROSS-REFERENCES TO RELATED APPLICATIONS

This application is a continuation-in-part of U.S. patent application Ser. No. 12/971,671 filed on Dec. 17, 2010, now U.S. Pub. No. 2011/0090648, which is a divisional of U.S. patent application Ser. No. 12/143,143 filed on Jun. 20, 2008, now U.S. Pub. No. 2009/0207574, now abandoned, which claims priority of Taiwan application Ser. No. 97105555 filed on Feb. 18, 2008. The entirety of the above-mentioned patent applications are hereby incorporated by reference herein and made a part of specification.

### BACKGROUND OF THE INVENTION

I. Field of the Invention

The present invention relates to a package structure. More particularly, the present invention relates to an electronic package structure.

II. Description of the Prior Art

Electronic package structures are formed by complicated package processes. Different electronic package structures have different electrical performances and capacities of heat dissipation, and therefore a designer may select an electronic package structure with a desired electrical performance and capacity of heat dissipation according to a design requirement.

FIG. 1 is a schematic diagram of a conventional electronic package structure. Referring to FIG. 1, the conventional electronic package structure 100 includes a printed circuit board (PCB) 110 and a plurality of electronic elements 120. The electronic elements 120 are disposed on a surface 112 of the PCB 110 and electrically connected to the PCB 110. The PCB 110 has a plurality of pins 116 extending out from another surface 114 of the PCB 110 to be electrically connected to an electronic device, for example, a motherboard (not shown).

FIG. 2 is a schematic diagram of another conventional electronic package structure. Referring to FIG. 2, the conventional electronic package structure 200 includes a circuit substrate 210 and a plurality of electronic elements 220. The electronic elements 220 are disposed on a surface 212 of the circuit substrate 210, and electrically connected to the circuit substrate 210 via a wire bonding technology, a flip-chip bonding technology or a surface mount technology. Moreover, the conventional electronic package structure 200 may be electrically connected to an electronic device, for example, a motherboard (not shown), via a solder paste or a plurality of solder balls (not shown).

It should be noted that the electronic elements 120 of the conventional electronic package structure 100 are all disposed on the surface 112 of the PCB 110, and the electronic elements 220 of the conventional electronic package structure 200 are all disposed on the surface 212 of the circuit substrate 210. Therefore, in the conventional electronic package structures 100 and 200, spatial utilization of the PCB 110 and the circuit substrate 210 is relatively low, and sizes of the conventional electronic package structures 100 and 200 are relatively great.

### SUMMARY OF THE INVENTION

In accordance with the present invention, an electronic package structure can achieve a relatively high utilization of an internal space thereof, so that a size of the electronic package structure can be reduced.

In one embodiment of the present invention, an electronic package structure includes at least a first electronic element, a second electronic element and a first lead frame. The second electronic element includes a body having a cavity. The first electronic element is disposed in the cavity. The lead frame has a plurality of leads. Each of the leads has a first end and a second end, and the first end of at least one of the leads extends to the cavity to electrically connect the first electronic element.

In one embodiment of the present invention, an electronic package structure includes at least one first electronic element, a second electronic element and a lead frame. The second electronic element includes a body having a first surface. The lead frame has a plurality of leads. Each of the leads has a first end and a second end. The first ends are disposed on the first surface, and the first electronic element is disposed on the first surface and electrically connected to at least one of the leads.

In one embodiment, an electronic package structure includes a circuit substrate, at least one first electronic element and a second electronic element. The circuit substrate has a first surface. The first electronic element is disposed on the first surface of the circuit substrate and electrically connected to the circuit substrate. The second electronic element is disposed above the first surface of the circuit substrate and includes a body and a plurality of leads. Each of the leads has a first end and second end, and the second end of each of the leads extends out from the body to electrically connect the circuit substrate. The first electronic element is located among the body of the second electronic element, the first surface of the circuit substrate and the leads.

In the above embodiments of the present invention, since the first electronic element can be disposed in the cavity of the second electronic element or on the second electronic element, or the second electronic element can be stacked on the first electronic element, compared to the conventional electronic package structures, utilization of an internal space of the electronic package structure is relatively high.

In order to make the aforementioned and other objects, features and advantages of the present invention comprehensible, a preferred embodiment accompanied with figures is described in detail below.

The detailed technology and above preferred embodiments implemented for the present invention are described in the following paragraphs accompanying the appended drawings for people skilled in this field to well appreciate the features of the claimed invention.

### BRIEF DESCRIPTION OF THE DRAWINGS

The foregoing aspects and many of the accompanying advantages of this invention will become more readily appreciated as the same becomes better understood by reference to the following detailed description when taken in conjunction with the accompanying drawings, wherein:

FIG. 1 is a schematic diagram of a conventional electronic package structure.

FIG. 2 is a schematic diagram of another conventional electronic package structure.

FIG. 3A is a schematic diagram of an electronic package structure according to a first embodiment of the present invention.

FIG. 3B is a schematic diagram of another electronic package structure according to the first embodiment of the present invention.

FIG. 3C is a schematic diagram of another electronic package structure according to the first embodiment of the present invention.

FIG. 3D is a schematic diagram of still another electronic package structure according to the first embodiment of the present invention.

FIG. 4A is a schematic diagram of an electronic package structure according to a second embodiment of the present invention.

FIG. 4B is a schematic diagram of another electronic package structure according to the second embodiment of the present invention.

FIG. 5A is a schematic diagram of an electronic package structure according to a third embodiment of the present invention.

FIG. 5B is a schematic diagram of another electronic package structure according to the third embodiment of the present invention.

FIG. 6 is a side view of an embodiment of an inductor, which can be used in the electronic package structure as shown in FIGS. 3A-5B.

FIG. 7 is a schematic diagram of an embodiment of a system that incorporates one of the electronic package structures as shown in FIGS. 3A-5B.

### DETAILED DESCRIPTION OF THE INVENTION

The detailed explanation of the present invention is described as following. The described preferred embodiments are presented for purposes of illustrations and descriptions, and they are not intended to limit the scope of the present invention.

### First Embodiment

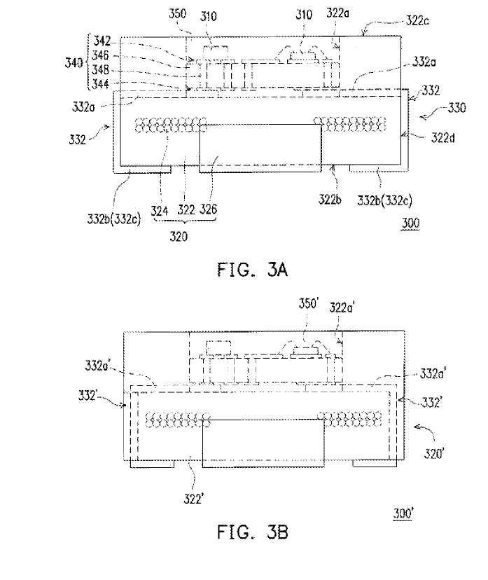

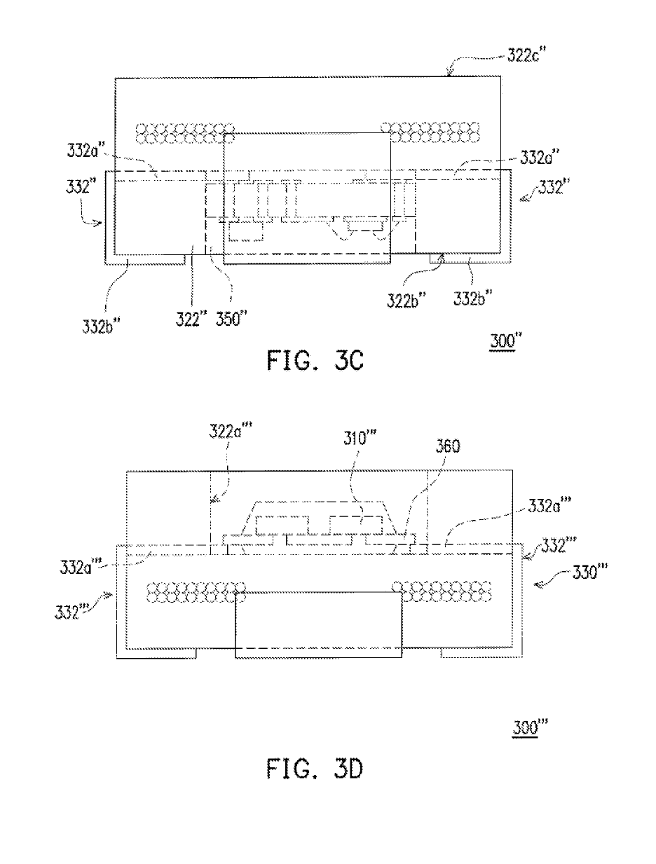

FIG. 3A is a schematic diagram of an electronic package structure according to a first embodiment of the present invention. Referring to FIG. 3A, the electronic package structure 300 includes at least one first electronic element 310 (two first electronic elements are illustrated in FIG. 3A), a second electronic element 320 and a first lead frame 330. The electronic package structure 300 is generally applied to a power-supply module, a voltage regulator module, a network adapter, a graphics processing unit, a DC/DC converter or a point-of-load (POL) converter. Each of the first electronic elements 310 can be a power-supply component such as a logical control element (a controller), a driving element, a metal-oxide-semiconductor field effect transistor (MOSFET), an insulated gate bipolar transistor (IGBT), a diode or a passive element. The passive element can be a capacitor, an inductor with lesser inductance, or a resistor.

The second electronic element 320 includes a body 322 having a cavity 322a. The first electronic elements 310 are disposed in the cavity 322a. In the embodiment, the body 322 of the second electronic element 320 has a first surface 322b, a second surface 322c opposite to the first surface 322b and a side surface 322d. The cavity 322a sinks in a direction from the second surface 322c towards the first surface 322b. The side surface 322d connects the first surface 322b and the second surface 322c. Besides, the second electronic element 320 can be an energy-storage element used for storing electric energy. In detail, the second electronic element 320 further includes a coil 324 and a plurality of first external electrodes 326. The coil 324 is disposed within the body 322. The first external electrodes 326 are respectively connected to two opposite ends of the coil 324, and extend outside the body 322 to locate on the first surface 322b and the side surface 322d. The body 322 comprising a magnetic body encloses the coil 324. The second electronic element 320 can be an inductive element, such as an inductor, with a greater inductance and a greater size than the first electronic elements 310.

The first lead frame 330 has a plurality of leads 332. Each of the leads 332 has a first end 332a and a second end 332b, and the first end 332a of each of the leads 332 can be embedded in the body 322 and extends to the cavity 322a for electrically connecting to the first electronic elements 310. The second end 332b of each of the leads 332 is disposed on the first surface 322b of the body 322 to form a second external electrode 332c, and a part of each of the leads 332 connecting the first end 332a and the second end 332b is disposed on the side surface 322d of the body 322.

In the present embodiment, the electronic package structure 300 further includes a platform, such as a circuit substrate 340, and an insulating encapsulant 350. The circuit substrate 340 is disposed in the cavity 322a of the body 322. The first electronic elements 310 can be disposed on the circuit substrate 340 and electrically connected to the circuit substrate 340. The circuit substrate 340 is electrically connected to the first end 332a of each of the leads 332 extending to the cavity 322a. The first electronic elements 310 may be electrically connected to the circuit substrate 340 via a wire bonding technology, a flip-chip bonding technology or a surface mount technology. The circuit substrate 340 has a first circuit layer 342, a second circuit layer 344, a dielectric layer 346 disposed between the first circuit layer 342 and the second circuit layer 344, and at least a conductive channel 348. The first electronic elements 310 are disposed on the first circuit layer 342, and the conductive channel 348 penetrates the dielectric layer 346 for electrically connecting the first circuit layer 342 and the second circuit layer 344. It should be noted that the circuit board 340 of the electronic package structure 300 may be omitted according to a design requirement of a designer, though it is not illustrated.

Moreover, the insulating encapsulant 350 is disposed in the cavity 322a and encapsulates the first electronic elements 310 and the circuit substrate 340 for protecting the first electronic elements 310 and the circuit substrate 340, and enhancing a whole mechanical strength of the electronic package structure 300.

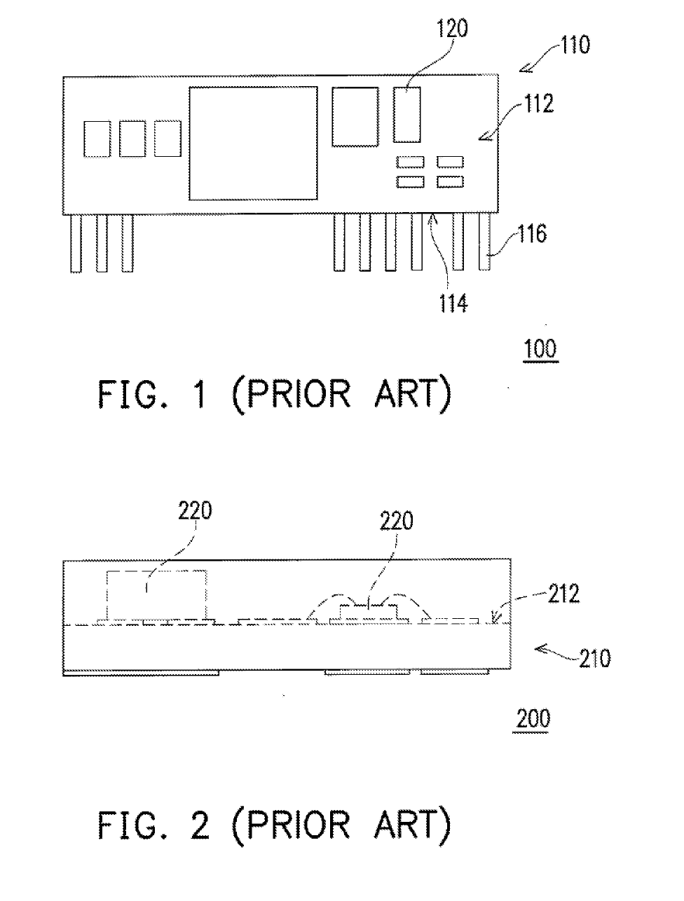

Since the first electronic elements 310 and the circuit substrate 340 are disposed in the cavity 322a of the second electronic element 320, compared to a conventional electronic package structures of FIG. 1 and FIG. 2, utilization of an internal space of the electronic package structure 300 is relatively high, and the first electronic elements 310 and the circuit substrate 340 can be protected by the cavity 322a. Besides, since the insulating encapsulant 350 is disposed in the cavity 322a, material of the insulating encapsulant 350 can be directly filled into the cavity 322a without aiding of extra mold during formation of the insulating encapsulant 350.

FIG. 3B is a schematic diagram of another electronic package structure according to the first embodiment of the present invention. Referring to FIG. 3A and FIG. 3B, a difference between the electronic package structure 300′ and the electronic package structure 300 is that a part of each lead 332′ connecting a first end 332a′ and a second end 332b′ penetrates a body 322′. Besides, the insulating encapsulant 350 of the electronic package structure 300 is different from a magnetic encapsulant 350′ of the electronic package structure 300′. The magnetic encapsulant 350′ is disposed in a cavity 322a′ of the body 322′. Therefore, if a second electronic element 320′ is an inductive element, an inductive characteristic of the second electronic element 320′ influenced by the cavity 322′ then can be compensated by the magnetic encapsulant 350′. It should be noted that a part of each of the leads 332 connecting the first end 332a and the second end 332b may also penetrate the body 322 according to a design requirement, though it is not illustrated.

FIG. 3C is a schematic diagram of another electronic package structure according to the first embodiment of the present invention. Referring to FIG. 3A and FIG. 3C, a difference between the electronic package structure 300″ and the electronic package structure 300 is that a cavity 322a″ of a body 322″ sinks in a direction from a first surface 322b″ towards a second surface 322c″. It should be noted that an insulating encapsulant 350″ can be substituted by a magnetic encapsulant according to a design requirement, and a part of each lead 332″ connecting a first end 332a″ and a second end 332b″ may also penetrate the body 322″ according to a design requirement, though it is not illustrated.

FIG. 3D is a schematic diagram of still another electronic package structure according to the first embodiment of the present invention. Referring to FIG. 3A and FIG. 3D, a second lead frame 360 is applied in the electronic package structure 300′″ for substituting the circuit substrate 340 of the electronic package structure 300 according to a design requirement. A plurality of first electronic elements 310′″ are disposed on the second lead frame 360 and electrically connected to the second lead frame 360. The second lead frame 360 is electrically connected to a first end 332a′″ of each lead 332′″ of a first lead frame 330′″ that extends to a cavity 322a′″.

### Second Embodiment

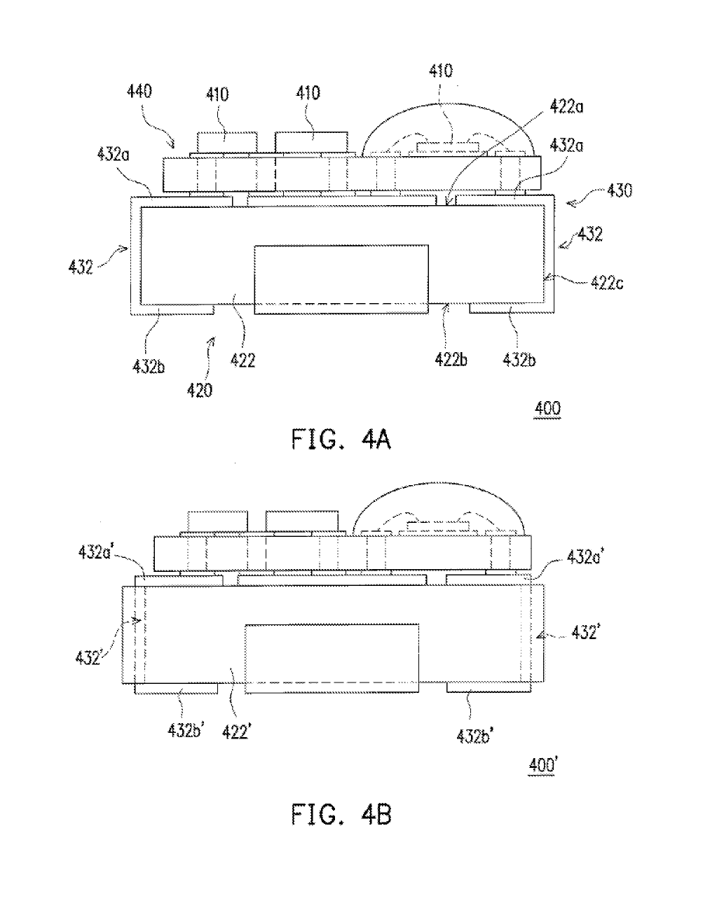

FIG. 4A is a schematic diagram of an electronic package structure according to a second embodiment of the present invention. Referring to FIG. 4A and FIG. 3A, a difference between the electronic package structure 400 of the second embodiment and the electronic package structure 300 of the first embodiment is that a body 422 of a second electronic element 420 does not have the cavity 322a. In detail, a first end 432a of each lead 432 of a lead frame 430 is disposed on a first surface 422a of a body 422, and a plurality of first electronic elements 410 are disposed on the first surface 422a and electrically connected to the leads 432. Moreover, a second end 432b of each of the leads 432 is disposed on a second surface 422b of the body 422 opposite to the first surface 422a, and a part of each of the leads 432 connecting the first end 432a and the second end 432b is disposed on a side surface 422c of the body 422.

Furthermore, a platform, such as a circuit substrate 440, is disposed on the first surface 422a and electrically connected to the leads 432, and the first electronic elements 410 are disposed on the circuit substrate 440 and electrically connected to the circuit substrate 440. It should be noted that the circuit substrate 440 of the electronic package structure 400 may be omitted according to a design requirement of the designer, or the circuit substrate 440 may be substituted by a lead frame, though it is not illustrated.

FIG. 4B is a schematic diagram of another electronic package structure according to the second embodiment of the present invention. Referring to FIG. 4A and FIG. 4B, a difference between the electronic package structure 400′ and the electronic package structure 400 is that a part of each lead 432′ connecting a first end 432a′ and a second end 432b′ penetrates a body 422′.

### Third Embodiment

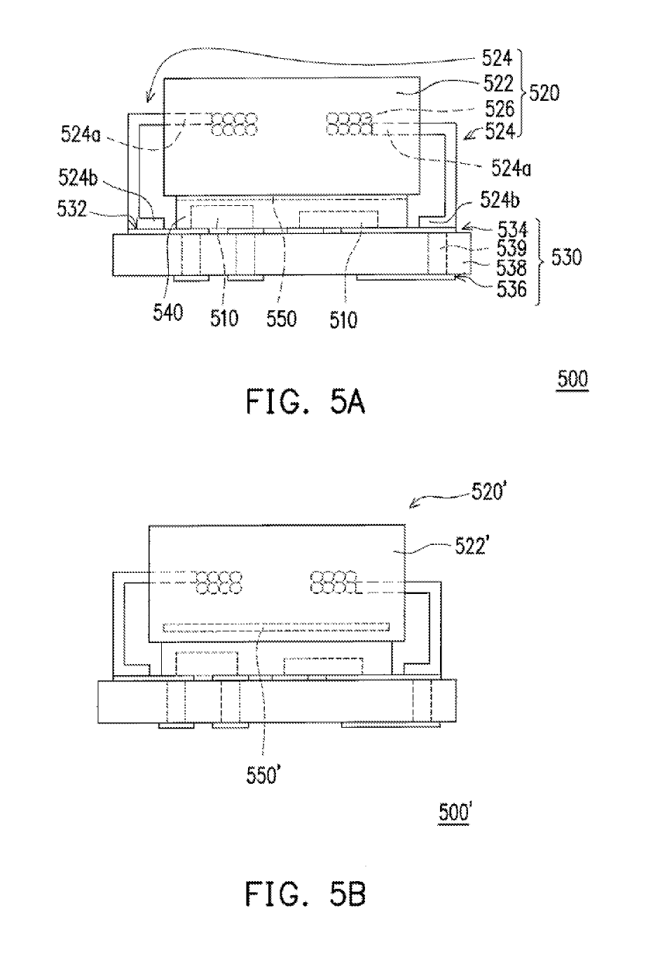

FIG. 5A is a schematic diagram of an electronic package structure according to a third embodiment of the present invention. Referring to FIG. 5A, in the electronic package structure 500 of the present embodiment, a plurality of first electronic elements 510 are disposed on a first surface 532 of a platform, such as a printed circuit board or a circuit substrate 530 as shown in FIG. 5A, and electrically connected to the circuit substrate 530. A second electronic element 520 is disposed above the first surface 532 of the circuit substrate 530. The first electronic elements 510 are located between a body 522 of the second electronic element 520 and the first surface 532 of the circuit substrate 530, and the first electronic elements 510 are located between leads 524 of the second electronic element 520. In other words, in the present embodiment, the second electronic element 520 covers the first electronic elements 510. Besides, an insulating encapsulant 540 is disposed between the second electronic element 520 and the circuit substrate 530 and encapsulating the first electronic elements 510 for protecting the first electronic elements 510 and enhancing a whole mechanical strength of the electronic package structure 500. Alternatively, the insulating encapsulant 540 can also be disposed to encapsulate at least part of the circuit substrate 530, the first electronic elements 510 and the second electronic element 520, or completely encapsulate all of them. Moreover, the circuit substrate 530 may further include at least a conductive channel 539, and each of the conductive channels 539 penetrates a dielectric layer 538 for electrically connecting a first circuit layer 534 and a second circuit layer 536. At least one of the conductive channels 539 (for example, the two conductive channels 539 located at a left side of FIG. 5A) is located below at least one of the first electronic elements 510 (for example, the first electronic element 510 located at the left side of FIG. 5A), so that heat generated by the first electronic element 510 located at the left side may be quickly transmitted to where is outside the electronic package structure 500 via the two conductive channels 539 located at the left side. A second end 524b of each of the leads 524 of the second electronic element 520 extends out from the body 522 to electrically connect the circuit substrate 530. The second electronic element 520 may be an inductive element including a coil 526. The body 522 which is a magnetic wrap wraps the coil 526, and a first end 524a of each of the leads 524 is connected to one of two opposite ends of the coil 526.

Still referring to FIG. 5A, an embodiment of a method for manufacturing the electronic package structure 500 is described.

First, the plurality of first electronic elements 510 and any other components of the electronic package structure 500 are mounted to the circuit substrate 530, the bottom pads of the components are soldered to corresponding pads of the circuit substrate.

Next, the upper pads (if any are present) of the components are wire bonded to corresponding pads of the circuit substrate 530.

Then, the leads 524 of the second electronic element 520 are shaped, and the second electronic element 520 is mounted to the circuit substrate 530, e.g., by soldering the leads to corresponding pads of the circuit substrate.

Next, the insulating encapsulant 540 is formed between the second electronic element 520 and the circuit substrate 530 and encapsulating the first electronic elements 510 by conventional methods. Alternatively, the insulating encapsulant 540 can also be formed to encapsulate at least part of the circuit substrate 530, the first electronic elements 510 and the second electronic element 520, or completely encapsulate all of them by conventional methods, such as injection molding of epoxy resin.

Then, the leads (not shown in FIG. 5A) of the electronic package structure 500 are shaped, and the electronic package structure can be tested and shipped to customers.

It should be noted that the electronic package structure 500 further includes an electromagnetic-interference-shielding element (EMI-shielding element) 550 covering the first electronic elements 510. In the present embodiment, the EMI-shielding element 550 is disposed on the body 522 of the second electronic element 520, and is located between the body 522 of the second electronic element 520 and the circuit substrate 530. Therefore, during operation of the electronic package structure 500, it may be reduced by means of the EMI-shielding element 550 that electrical signals transmitted in the circuit substrate 530 is interfered by a magnetic force generated by the second electronic element 520 which functions as an inductive element.

FIG. 5B is a schematic diagram of another electronic package structure according to the third embodiment of the present invention. Referring to FIG. 5A and FIG. 5B, a difference between the electronic package structure 500′ and the electronic package structure 500 is that an EMI-shielding element 550′ of the electronic package structure 500′ is disposed in a cavity 522′ of a second electronic element 520′.

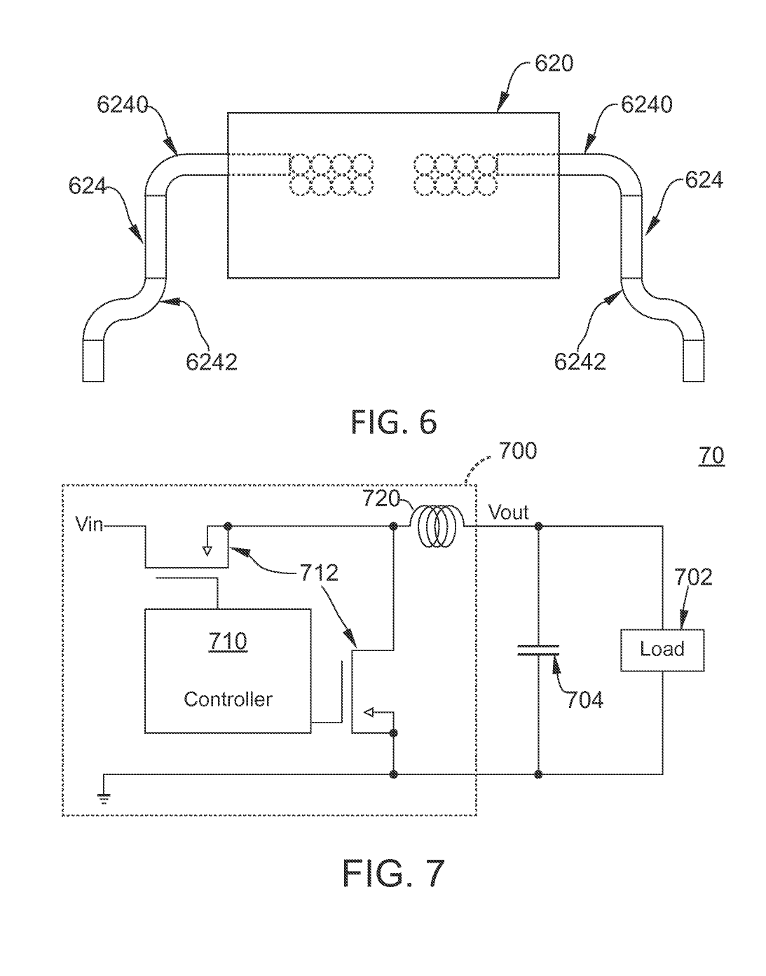

FIG. 6 is a side view of an embodiment of a second electronic element such as an inductor 620, which can be used in the aforementioned electronic package structure. Each of the leads 624 is extensions of the inductor winding and has two bends 6240 and 6242. For example, the angles of the bends 6240 and 6242 can be between approximately 30 and 90 degrees. Furthermore, although not shown, the bottoms of the leads 624 can also be bent at an approximately 90 degree angle to increase the mounting stability of the inductor 620. Moreover, although only two leads 624 are shown, the inductor 620 can have more than two leads (e.g., four leads), to increase the mounting stability of the inductor, to reduce the lead resistance, etc.

FIG. 7 is a schematic diagram of an embodiment of a system 70, which can incorporate one or more embodiments of the aforementioned electronic package structure; for example, the electronic package structure can be a power-supply module 700 as shown in FIG. 7, where the module 700 includes a buck converter.

In addition to the module 700, the system 70 includes an apparatus, such as a load 702, which receives a regulated voltage Vout from the module, and a filter capacitor (C) 704. Examples of the load 702 include an integrated circuit such as a processor or memory. In operation, a power-supply component, such as the controller 710 as shown in FIG. 7, controls the other power-supply component, such as the transistors 712 as shown in FIG. 7, to alternately couple an input voltage Vin and reference voltage (e.g., ground) to a phase inductor 720 in a manner that generates the regulated voltage Vout from Vin.

Still referring to FIG. 7, alternate embodiments of the system 70 are contemplated. For example, embodiments described above in conjunction with FIGS. 3A-5B can be applicable to the system 70. Furthermore, although described as a buck converter, the module 700 can include any other type of power supply such as a buck-boost converter. Moreover, the module 700 can include additional components such as a filter inductor coupled between the phase inductor 720 and the load 702. In addition, although described as being external to the module 700, the filter capacitor 704 can be part of the module.

In summary, in the aforementioned embodiments of the present invention, since the first electronic elements can be disposed in the cavity of the second electronic element or can be disposed on the second electronic element, or the second electronic element can be stacked on the first electronic elements, compared to the conventional electronic package structures, utilization of an internal space of the electronic package structure is relatively high, so that a size of the electronic package structure can be reduced.

It will be apparent to those skilled in the art that various modifications and variations can be made to the structure and method of the present invention without departing from the scope or spirit of the invention. In view of the foregoing, it is intended that the present invention cover modifications and variations of this invention provided they fall within the scope of the following claims and their equivalents.

What is claimed is:

1. A power-supply module, comprising:
at least one power-supply component;
an inductor disposed over the at least one power-supply component; and
a package, wherein the at least one power-supply component and the inductor are disposed within the package.

2. The power-supply module as claimed in claim 1, wherein the package comprises insulating material to encapsulate the at least one power-supply component and the inductor.

3. The power-supply module as claimed in claim 2, wherein the insulating material includes epoxy resin.

4. The power-supply module as claimed in claim 1, wherein the at least one power-supply component is a controller.

5. The power-supply module as claimed in claim 1, wherein the at least one power-supply component is a transistor.

6. The power-supply module as claimed in claim 1, wherein the at least one power-supply component is a resistor.

7. The power-supply module as claimed in claim 1, wherein the at least one power-supply component is a capacitor.

8. The power-supply module as claimed in claim 1, wherein the inductor comprises a plurality of leads that support the inductor over the at least one power-supply component.

9. The power-supply module as claimed in claim 1, further comprising:
a platform, wherein the at least one power-supply component and the inductor are mounted to the platform.

10. The power-supply module as claimed in claim 1, further comprising:
a printed circuit board, wherein the at least one power-supply component and the inductor are mounted to the printed circuit board.

11. The power-supply module as claimed in claim 1, further comprising:
a circuit substrate, wherein the at least one power-supply component and the inductor are mounted to the circuit substrate.

12. A system, comprising:
a power-supply module, comprising:
at least one power-supply component;
an inductor, disposed over the power-supply components;
a package, wherein the at least a power-supply component and the inductor are disposed within the package; and
a supply output node; and
an apparatus, coupled to the supply output node.

13. The system as claimed in claim 12, wherein the apparatus comprises an integrated circuit.

14. The system as claimed in claim 13, wherein the integrated circuit comprises a processor.

15. The system as claimed in claim 13, wherein the integrated circuit comprises a memory.

16. A method, comprising the steps of:
a. disposing an inductor over at least one power-supply component; and
b. forming a package encapsulating the inductor and the at least one power-supply component.

17. The method as claimed in claim 16, wherein the step a comprises the sub-steps of:
a1. mounting the at least one power-supply component to a platform; and
a2. mounting the inductor to the platform over the at least one power-supply component.

18. The method as claimed in claim 16, wherein the package comprises epoxy resin.

19. The method as claimed in claim 16, wherein the inductor comprises a plurality of leads that support the inductor over the at least one power-supply component.

20. The method as claimed in claim 17, wherein the platform is a circuit substrate.
